(19) United States
(12) Patent Application Publication
(10) Pub. No.: US 2008/0022798 A1
(43) Pub. Date: Jan. 31, 2008

(54) Running Gear And Production Method

(75) Inventor: Dirk Zeise, Kassel (DE)

Correspondence Address: CROWELL & MORING LLP;INTELLECTUAL PROPERTY GROUP, P.O. BOX 14300, WASHINGTON, DC, 20044-4300, US

(73) Assignee: DamilerChrysler AG, Stuttgart (DE)

(21) Appl. No.: 10/582,721

(22) PCT Filed: Nov. 23, 2004
(86) PCT No.: PCT/EP04/13262

§ 371 Date: May 22, 2007

(30) Foreign Application Priority Data
Dec. 13, 2003 (DE) 103 58 503.6

(51) Int. Cl. B21K 1/30; F16H 1/20; F16H 55/02

(52) U.S. Cl. 74/424.5; 29/893.35; 74/547

(57) ABSTRACT

A running gear toothing for gearwheels and a process for producing such running gear is provided. In order to be able to work complex shapes (e.g. reinforcing ribs) into running gear, a preforged or precast gearwheels are produced oversized, and are then finished using an electrochemical erosion process. The invention eliminates complex machining operations and permits gear teeth finishing in highly spaced-constrained applications, thereby eliminating the need for production and assembly complex multi-component gears.

This application is a national phase application of International application PCT/EP2004/013262 filed Nov. 23, 2004 and claims the priority of German application No. 103 58503.6, filed Dec. 13, 2003, the disclosures of which are expressly incorporated by reference herein.

### BACKGROUND AND SUMMARY OF THE INVENTION

The invention relates to a running gear and to a method for producing a running gear.

German patent document DE-OS 29 26 255 describes a toothed gearwheel which is constructed with a running gear and a shifting gear. The shifting gear is produced electrochemically or electroerosively or by precision forging. The shifting gear is deposited electrochemically or electroerosively.

The object of the invention is to create a large geometric tolerance for running gears.

It is possible to produce hypoid toothing or other complex running gear geometries by either precision forging or casting.

Cost-effective running gears can be produced with a large geometric play by the electrochemical finishing of these precision forged or cast running gears. In the electrochemical finishing process, material is eroded from the workpiece having the running gear using a forming electrode by supplying an electrolyte while applying voltage.

It is particularly advantageous when the feedability and deformability in one direction are taken into account when the geometry of the workpiece is chosen. This makes it possible to mass-produce the workpiece and the running gear.

In a particularly advantageous development of the invention, all teeth of the ring gear are processed in a single step. Since the precision of the toothing depends mainly on the precision of the electrode, a high degree of processing precision and repeatability is achieved. Materials that are difficult to process, and even hardened materials, can be processed using this method. One such material which is not easy to process is thermo-treated austenitic ductile iron material.

In particularly advantageous fashion, stiffening ribs or stiffening covers can be provided, extending between at least two teeth. This way, the teeth have a very high bending resistance, so the root stability is also very high. Geometric reinforcing measures are also possible, in which conventional milling, grinding, or lapping crosses or penetrates the tool paths. The increased bending resistance brings benefits with respect to the running smoothness and useful life of the running gear. Advantageously, larger gains in torque transmission capability can be achieved than with, for example, other methods for optimizing the tooth geometry or surface coatings.

Since it is not necessary to account for tool paths, all conceivable toothing and reinforcing geometries are be implemented. These reinforcing elements can run in the perimeter of the toothed gearwheel. For instance, the reinforcing geometries can run along the outer or inner perimeter or in the center of the tooth width. Reinforcements can also be provided in the root in the form of roundings dimensioned according to the load.

In a particularly advantageous fashion, a reinforcing element, for instance a reinforcing cover, can be provided on the back of the bevel gears, which leads to an appreciable gain in root rigidity.

Bevel gears with reinforcing covers can also be provided especially advantageously as complete units. If such bevel gears are provided with a spiral toothing, in addition to the transverse merging of bevel gear and electrode, these two part can also be mutually rotated to the extent of the existing spiral angle. I.e., the bevel gear is rotated into the electrode and back out, and the electrode is screwed onto the bevel gear and back down again.

It is particularly advantageous when toothed gearwheels are produced with reinforcing covers on both sides. Such toothed gearwheels comprise an even higher root rigidity. Such gearwheels can be generated particularly advantageously through the inserting of an electrode, which has the negative shape of one space between teeth, radially into said intervening space. This is a particularly advantageous way to ensure that the electrode is deformable in one direction. Following the finishing of the inter-tooth space, the toothed gearwheel is rotated by the tooth pitch. This is continued until the complete toothed gearwheel is finished. In order to increase the processing speed, a multilateral processing can also occur in this method, with several electrodes being inserted into the spaces between teeth simultaneously. This method is particularly advantageous for spur gears that are provided with reinforcing covers on both sides, particularly helical spur gears. If reinforcing covers are not provided on both sides, it is also possible to feed the electrode or electrodes with the negative shape to an electrochemical processing step from some other direction than radially.

In order to further increase processing speed, besides the foregoing multilateral processing, multi-piece processing is also possible in this method where individual electrodes are inserted into respective spaces between teeth. Here, multiple electrodes are led into the piece in synchronous fashion on a feed unit. Once the intervening spaces are finished, the pieces are further rotated according to the tooth pitch. This is continued until the toothed gearwheels are completely finished.

A particular advantage of the processing method of the invention is that it does not require separate tool entry and exit for milling, grinding, or lapping. Therefore, in the processing method of the invention, complex running gear geometries do not need to be designed with multi-part subassemblies that have to be joined after the teeth are finished, as is the case with a ring gear of a differential casing, for example. In the case of the one-piece ring gear differential casing unit, an annular electrode can be provided, which is pulled over the differential casing coaxially to same and which finishes it electrochemically in one process step while in a position in the region of the previously processed running gear. Subassembly interfaces still needed today can be eliminated not only in the case of the differential casing. All the measures made possible by the method of the invention add up to a large cost saving potential.

A particularly advantageous result of the invention is that it opens up the possibility of processing machines for producing partially complex toothing geometries which employ the method of the invention. Such processing machines of the invention having one or more electrodes and an electrolyte bath are less expensive than the gear machines which work by cutting, which are common today. As a result, the running gear manufacturers are less dependent on a few machine vendors.

The steering gear box is a particularly advantageous field of application of the invention. It is possible to preforge or precast the differential casing with the ring gear in a component with a size of a few tenths of a mm. This eliminates a complicated, highly stressed, and expensive interface.

The invention can be applied particularly advantageously in a crown gear differential according to German patent documents

DE 101 44 200.9
DE 103 39 425.7
DE 102 52 012.7-12
DE 103 08 800.8
DE 103 17 503.2
DE 103 39 423.0
DE 103 39 424.9

whose contents are incorporated by reference. The invention can also be applied to toothings having a reinforcing cover according to European patent document EP 1298353 A2, whose contents are incorporated by reference.

Several exemplifying embodiments of the invention will now be described in detail.

Other objects, advantages and novel features of the present invention will become apparent from the following detailed description of the invention when considered in conjunction with the accompanying drawings for example.

### BRIEF DESCRIPTION OF THE DRAWINGS

FIG. 1 a housing of a crown gear differential having a ring gear formed in one part and an electrode for the electrochemical machining of a running gear of the ring gear in accordance with an embodiment of the present invention,

FIG. 2 the housing from FIG. 1, after the electrode for the electrochemical machining has been moved toward the running gear up to a flushing gap,

FIG. 3 a crown gear differential in a cutaway view in perspective, representing cutting through a plane between a rotational axis of the crown gear differential and a geometric axis of differential gears, said crown gear differential comprising a housing according to FIG. 1 and FIG. 2 and differential gears according to FIG. 17 to FIG. 20, which are provided with reinforcing covers on both sides;

FIG. 4 the crown gear differential from FIG. 3 in a sectional view;

FIG. 5 a second embodiment of a housing for a crown gear differential, wherein a running gear of a ring gear comprises a reinforcing rib;

FIG. 6 the running gear with the reinforcing rib from FIG. 5 in detail;

FIG. 7 a bevel pinion of a crown gear differential embodiment with a reinforcing cover formed in one piece;

FIG. 8 the bevel pinion from FIG. 7 in another view;

FIG. 9 an electrode for the finishing of a running gear, which rotates to let in the bevel pinion from FIG. 7 and FIG. 8;

FIG. 10 the bevel pinion from FIG. 7 to FIG. 9, with the electrode for electrochemical machining moved toward the running gear up to a flushing gap;

FIG. 11 the electrode rotating to let out the bevel pinion from FIG. 7 to FIG. 10,

FIG. 12 a pinion shaft of a crown gear differential in another embodiment wherein the bevel gear with a spiral toothing comprises a reinforcing cover on each side;

FIG. 13 the pinion shaft from FIG. 12 and an electrode for finishing the spiral toothing, with an arrow representing the feed direction of the electrode;

FIG. 14 the pinion shaft from FIG. 12 and FIG. 13, with an electrode moved to the spiral toothing up to a flushing gap;

FIG. 15 a device and method for machining a number of pinion shafts according to FIG. 12 to FIG. 14, whereby several electrodes are conductively connected to one another;

FIG. 16 the device and method according to FIG. 15, whereby the electrodes are immersed in the space between the teeth of the spiral toothing up to a flushing gap;

FIG. 17 a toothed gearwheel which is provided with reinforcing covers on both sides, to which two diametrically opposed electrodes have been moved;

FIG. 18 the toothed gearwheel from FIG. 17, with the two electrodes inserted into diametrically opposed spaces between the teeth of the gearwheel;

FIG. 19 toothed gearwheels—particularly differential gears—which are provided with reinforcing covers on both sides, in a device for multiple machining, and

FIG. 20 the device and method according to FIG. 19, with the electrodes immersed into spaces between the teeth of the wheel up to a flushing gap.

### DETAILED DESCRIPTION

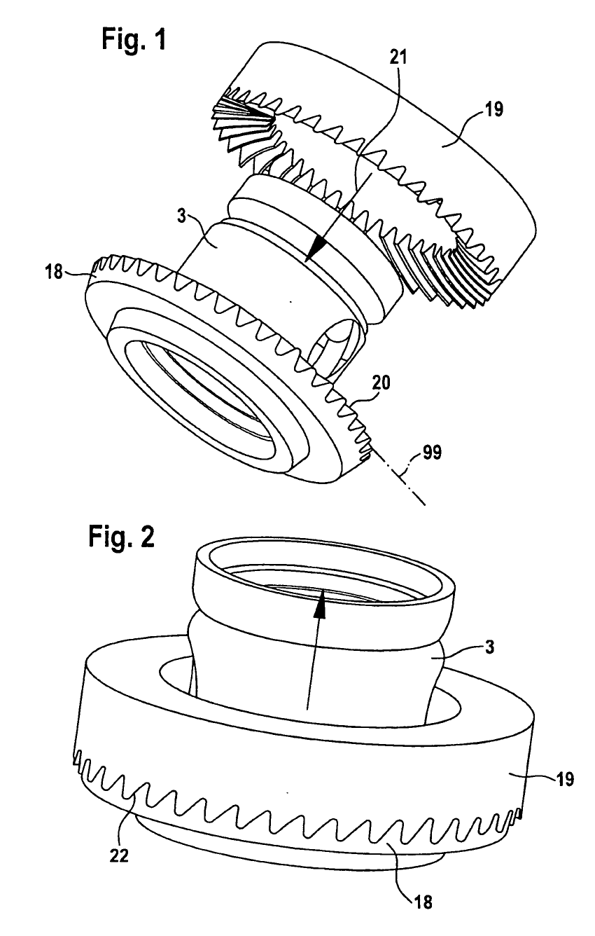

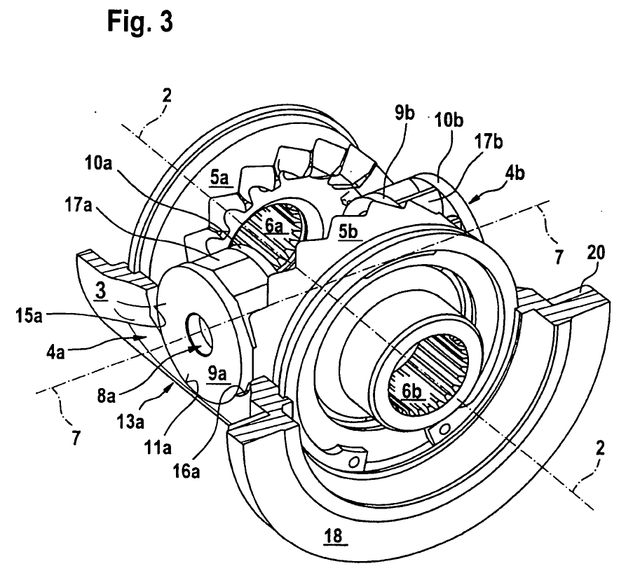

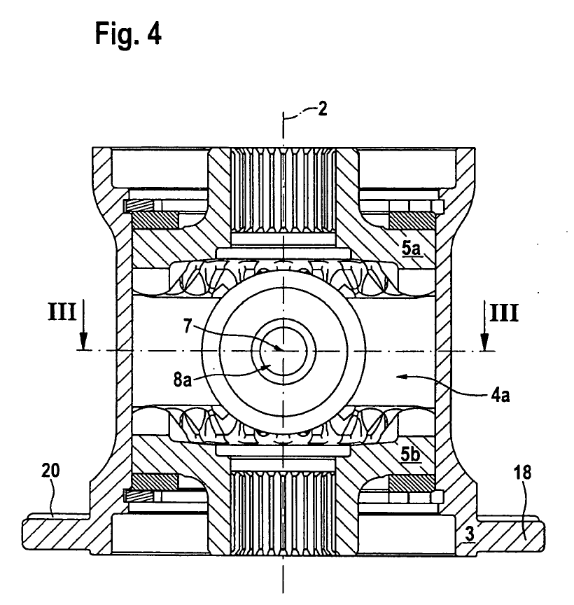

FIG. 1 shows a housing 3 of a crown gear differential. The crown gear differential is constructed in the assembled condition represented in FIG. 3 and FIG. 4. A ring gear 18 is formed on the housing 3. A running gear 20 of the ring gear 18 is an hypoid toothing. The housing 3 with the ring gear 18 can be produced from a signal part in particular by
precision forging or
precision casting.

### The housing 3 is preforged or precast from a thermo-treated austenitic ductile iron material with a size of 3/10 mm to 5/10 mm.

In an electrochemical gear machine, which is not represented, an electrode 19 is aligned coaxial to a rotational axis of the housing 3. The electrode 19 consists of an annular base body having substantially a negative shape of the running gear 20 incorporated in the side that faces the running gear 20. The electrode 21 is moved to the running gear 20 of the ring gear 18 coaxially according to arrow 21, until only a flushing gap 22 of approx. 1/100 mm remains between the electrode and the running gear as represented in FIG. 2. In order to account for this flushing gap and said material allowance, the negative shape is somewhat smaller than the final contour of the running gear 20. Since the direction of movement of the electrode 19 is coaxial to the axis of rotation of the housing 3, it is unnecessary to reserve any space radially within the running gear 20 for a tool outlet. Accordingly, the housing 3 is almost immediately adjacent radially within the running gear. This would not be possible with a technique involving cutting or grinding, because a tool outlet would have to be maintained within the running gear 20 for the path 99 of a milling cutter or grinding stone.

In the condition represented in FIG. 2, the ring gear 18 and the electrode 19 are immersed in an electrolyte bath. When the housing 3 is connected to one pole of a d.c. source on one side, and the electrode 19 is connected to another pole of the same d.c. source, a voltage exists between the housing 3 and the electrode 19, which erodes material from the surface of the running gear 20 evenly with the aid of the conductive electrolyte. Material is eroded until the final contour of the running gear 20 is formed. With this method, all the teeth of the running gear 20 are finished in a single machining process.

After the electrolytic finishing step, the electrode 19 is removed from the spaces between the teeth of the running gear 20 of the ring gear 18 in the direction of the arrow.

FIG. 3 represents the crown gear differential 1 in a cutaway view in perspective, as if slicing through a plane between a rotational axis 2 of the crown gear differential 1, or respectively crown gears 5a, 5b, and a geometric axis 7 of differential gears 4a, 4b.

This crown gear differential 1 comprises the cylindrical housing 3, whose rotational axis 2 is usually congruent with a geometric axis of an axle shaft which is not represented.

The housing 3 is constructed in one piece with the ring gear 18 on one end of the axis.

The housing 3 comprises two diametrically opposed recesses 13a, 13b located centrally along the axis, in which the straight-toothed differential gears 4a, 4b are mounted radially in relation to their geometric axis 7. The housing recess 13b is visible in FIG. 4. The differential gears 4a, 4b comprise a spur toothing 17a, 17b. The geometric axis 7 is perpendicular to the rotational axis 2. Arranged centrally in these differential gears 4a, 4b are recesses 8a, 8b, of which recess 8b is visible in FIG. 3. Each of the two differential gears 4a, 4b comprise a disk shaped reinforcing cover 9a, 10a, or respectively, cover 9b, 10b, on the top and bottom axially relative to its axis 7, through which the recesses 8a, 8b also run. These disk shaped reinforcing covers 9a, 10a, 9b, 10b are mounted in the housing 3 radially in arc shaped margin regions 11a, 12a, 20a, 14a, 11b, 12b, 20b, 14b of the two housing recesses 13a, 13b, of which only the arc shaped margin region 11a is visible in FIG. 3. These arc shaped margin regions 11a, 12a, 20a, 14a, 11b, 12b, 20b, 14b are located peripherally relative to the rotational axis 2 in order to transmit driving torque from the housing 3 to the differential gears 4a, 4b over the largest possible area. In the axial direction the housing recesses 13a, 13b comprise margin regions 15a, 15b, 16a, 16b at a distance from the differential gears, which regions ensure lubricant crossflow and thus guarantee reliable lubricant supply to the radial bearing of the differential gears 4a, 4b and for meshing. In such a meshing process, the differential gears 4a, 4b, are meshingly engaged with the crown gears 5a, 5b aligned concentrically to the rotational axis 2, which receive the axle shafts, which are not represented in detail, in a torque-proof fashion by means of a spline profile. An axial retaining ring DIN 472 braces the crown gears 5a, 5b against displacement relative to the housing 3 in the direction leading away from each other axially. Disposed between each of the crown gears 5a and 5b and its retaining ring is a distance disk for setting the axial distance between the two crown gears 5a, 5b.

FIG. 4 represents the crown gear differential 1 from FIG. 3 in a two-dimensional cutaway view. The figure also represents the differential gear 4a which lies across the section plane.

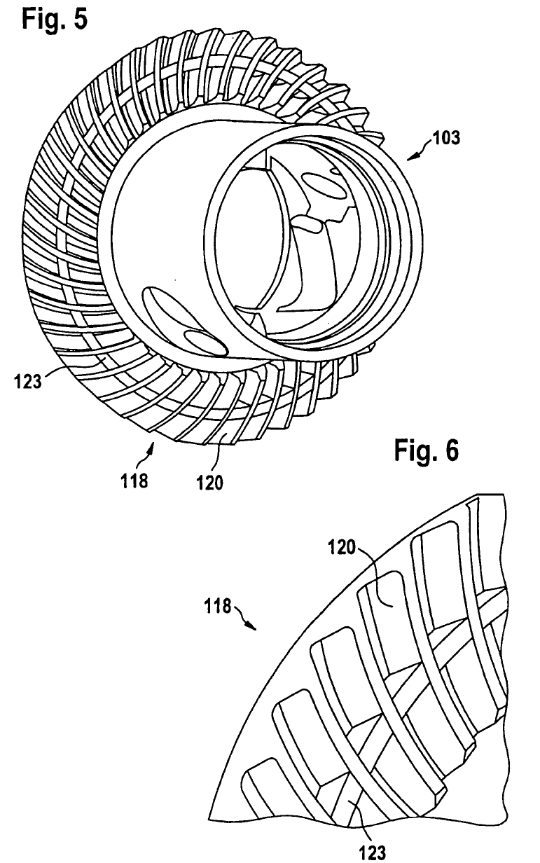

FIG. 5 represents a housing 103 of a crown gear differential like the one represented in FIG. 1 to FIG. 4. The housing 103 is joined with a ring gear 118. The machining technique is like the one represented according to FIG. 1 and FIG. 2. However, a circumferential reinforcing rib 123 was already incorporated into the running gear 120 during the precision forging or casting. This reinforcing rib 123 is disposed coaxial to the running gear 120 of the ring gear 118 and divides the running gear 120 into two bearing races of equal sizes radially. Since, as a result, the reinforcing rib 123 abuts each tooth centrally from its edge out, the deflection of each tooth is substantially smaller than that of the teeth in the first exemplifying embodiment. Furthermore, the root rigidity is very high. As a result,
the useful life of the toothing is higher,
the torque transmission is higher,
less vibration is generated,
shifting noise is reduced, and
less heating of the toothing occurs.

### The height of the reinforcing rib is equal to the height of the teeth in running gear 120.

The negative shape of the electrode, which is not represented in detail, is similar to the negative shape according to FIG. 1 and FIG. 2. However, the negative shape of the ring gear 118 [sic] according to FIG. 5 and FIG. 6 comprises a central recess on each “negative tooth” for the electrochemical erosion of the forged or cast reinforcing rib 118.

FIG. 7 represents a bevel pinion 225 of a crown gear differential in which a running gear is designed as a hypoid spiral toothing. This kind of bevel pinion 225 can be used to drive a ring gear 18 of a crown gear differential 1 according to FIG. 3 and FIG. 4. The bevel pinion 225 comprises a reinforcing cover 226 that is formed as one piece in order to create an especially high root rigidity. The reinforcing cover 226 is formed on the back of the bevel pinion 225.

FIG. 8 represents the bevel pinion from FIG. 7 in another view.

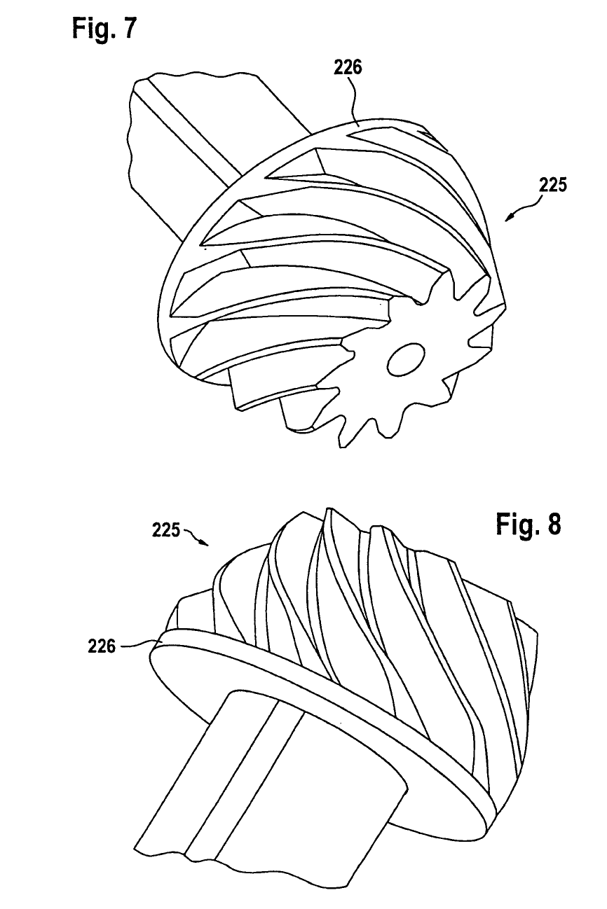

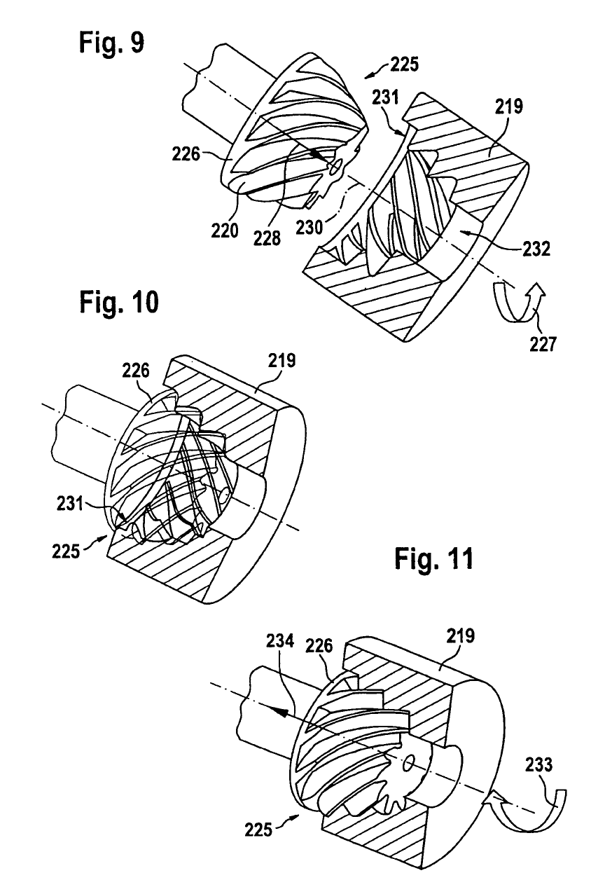

FIG. 9 represents the bevel pinion 225 from FIG. 7 and FIG. 8 plus an electrode for finishing a running gear 220 which rotates so that the bevel pinion from FIG. 7 and FIG. 8 can move in. The electrode 219 rotates in the direction of arrow 227, whereas the bevel pinion 225 is pushed in the direction of arrow 228 against the flush electrode 219. The electrode 219 rotates about the axis 230. The bevel pinion 225 is pushed along the axis 230, and the electrode 219 and the bevel pinion 225 constantly remain aligned concentric to the common axis 230.

The electrode 219 has a negative shape corresponding to the hypoid spiral toothing and the reinforcing cover 226 of the bevel pinion 225. Besides the direction in which the negative shape rotates in when the bevel pinion 225 rotates in for the electrochemical finishing, care must be taken, that the teeth of the running gear which run into the spaces between teeth of the electrode 219, so that a collision does not occur. This guarantees that the electrode 219 has a high useful life as a result of the lack of contact.

In an alternative development of the invention, the recess 231 in the negative form for the reinforcing cover 226 can be dispensed with.

FIG. 10 represents the bevel pinion 225 with the electrode for electrochemical machining moved to the running gear up to a flushing gap. In order to carry away
the bubbles which may develop during the electrochemical process
the electrolyte that heats up in the course of the process, and
the electrolyte that must be expelled from the electrode 219 when the bevel pinion 225 is moved in, the electrode 219 is provided with a continuous recess 232. At one end of the recess 232 is the electrolyte drain, and at the other end the bevel pinion 225 is moved in.

FIG. 11 represents how, when the bevel pinion 225 moves out, the electrode 219 rotates in the direction of arrow 233, while the bevel pinion 225 moves out linearly in the direction of arrow 234 at a synchronized speed.

In the machining method according to FIG. 9 to FIG. 11, the electrode 219 can alternatively be torque-proof, while the bevel pinion 225 rotates in. An equally acceptable alternative is for the electrode 219 to be displaced axially. Any possible combination of displacement and rotation is imaginable, depending on the respective embodiment of the electrochemical processing machine and the size and shape of the piece being machined.

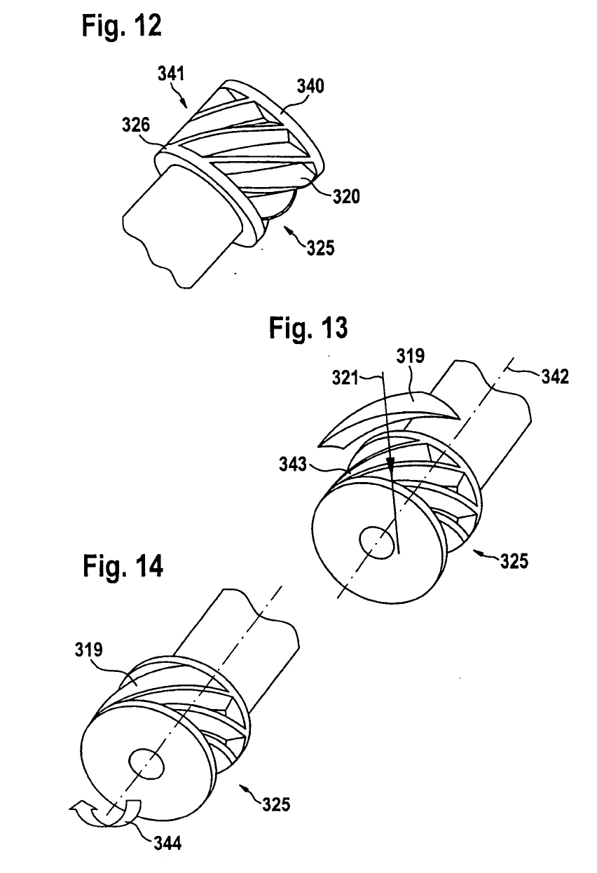

FIG. 12 represents another development of a pinion shaft 325 of a crown gear differential. This pinion shaft 325 can serve for driving a bevel pinion which forms the ring gear of an differential casing, as described in European patent document EP 1298353 A2 FIG. 7. The differential gears can be designed both as bevel gears and as spur wheels according to FIG. 3, FIG. 4 and FIG. 17 to FIG. 20 of the present application.

The running gear 320 of the pinion shaft 325 is a spiral toothing having reinforcing covers 326 and 340, respectively, on either side axially. The two reinforcing covers 326, 340 are constructed with the pinion head 341 as one piece, so the teeth of the running gear 320 with sharp corners merge into the reinforcing covers 326, 340.

FIG. 13 represents the pinion shaft 325 from FIG. 12 and an electrode 319 for finishing the spiral toothing, with arrow 321 indicating the direction in which electrode 319 moves.

The electrode 319 inserts perpendicularly to the longitudinal axis 342 of the pinion shaft 325 into a space 343 between teeth which is delimited by two teeth and the two reinforcing covers 326, 340, resulting in the situation represented in FIG. 14. In this intervening space 343, the electrode 319 comprises a flushing gap for the two teeth and the inner sides of the two reinforcing covers 326, 340, which makes possible the final finishing of the forged or cast running gear 320.

The special shape of the electrode 319 guarantees that it can be removed from the intervening space after the finishing process without difficulty. Once the electrode 319 is removed, the pinion shaft 325 is rotated one intervening space further about the longitudinal axis 342 indicated by arrow 344. Next, the electrode 319 is inserted into the next space between teeth.

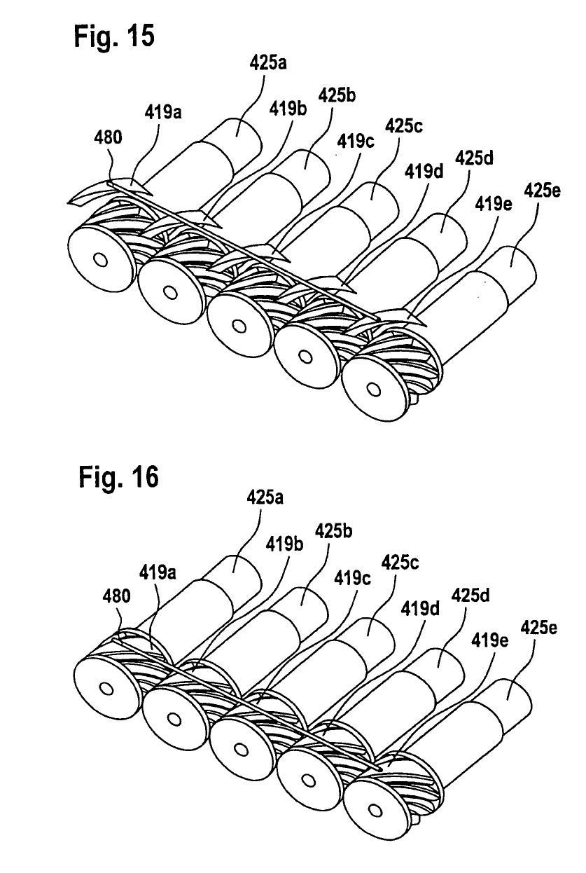

FIG. 15 and FIG. 16 represent a device and a method, respectively, for machining multiple pinion shafts according to FIG. 12 to FIG. 14. A number of spaces between teeth are machined simultaneously in one work process or one step. To that end, a number of electrodes 419a, 419b, 419c, 419d, 419e are connected to one another permanently by a conductive carrier bridge 480. The electrodes 419a, 419b, 419c, 419d, 419e are spaced apart evenly and aligned parallel to one another. Machining proceeds like in the exemplifying embodiment according to FIG. 12 to FIG. 14, except the entire unit consisting of carrier bridge 480 and electrodes 419a, 419b, 419c, 419d, 419e are displaced jointly, as a result of which each electrode 419a or 419b or 419c or 419d or 419e, respectively, drops into the space assigned to it. Next, all electrodes 419a, 419b, 419c, 419d, 419e are withdrawn from the spaces between teeth by means of the carrier bridge 480. All pinion shafts 425a, 425b, 425c, 425d, 425e, which are joined in synchronous fashion in the finishing machine, are then rotated one intervening space further. Following this, the next space is machined. These steps are passed through cyclically until all running gears of the shafts 425a, 425b, 425c, 425d, 425e are completely finished. In this operation, the machine is configured with very narrow tolerances because the flushing gap is very narrow between
the electrodes 419a, 419b, 419c, 419d, 419e and
the running gear and the reinforcing covers of the shafts 425a, 425b, 425c, 425d, 425e. These narrow tolerances, i.e., this quasi zero backlash, exists particularly in the components that are moved in synch. On one hand, the shafts 425a, 425b, 425c, 425d, 425e are rotated in synch, and on the other hand, the electrodes 419a, 419b, 419c, 419d, 419e are pushed into the spaces and removed again in synch.

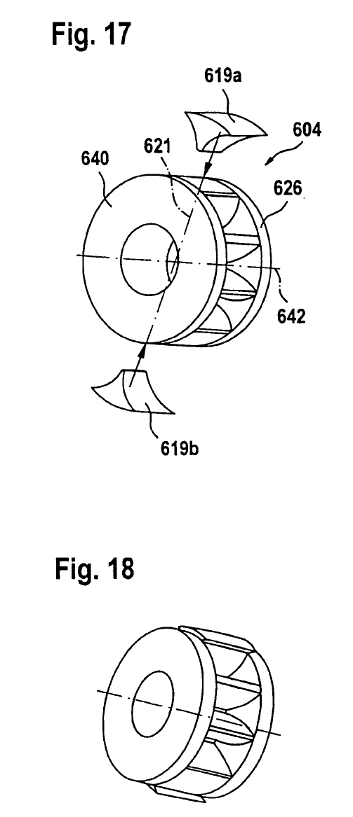

FIG. 17 and FIG. 18 represent a toothed gearwheel 604 that is provided with reinforcing covers on both sides, and, movable thereto, two diametrically opposed electrodes 619a, 619b. This kind of toothed gearwheel 604 which is provided with reinforcing covers 626, 640 on both sides can be used as a differential gear 4a of a differential crown gear unit 1, as represented in FIG. 3 and FIG. 4. For the machining of the toothed gearwheel 604, the two electrodes 619a, 619b, which are the shape of an intervening space, are pushed toward one another along a line of motion 621 running perpendicularly through the rotational axis 642 of the toothed gearwheel 604, until the two electrodes 619a, 619b are separated form the tooth edges and the insides of the reinforcing covers 626, 640 only by a flushing gap. Next, the electrochemical machining process is performed. Following that, the two electrodes 619a, 619b are removed from the intervening spaces along the line of motion 621, and the toothed gearwheel 604 is rotated one intervening space further. The use of two electrodes 619a, 619b instead of a single electrode halves the machining time. The two electrodes need not be situated diametrically opposed to one another. Any angle is imaginable as long as it [permits] the tooth pitch of the toothed gearwheel 604. The diametrical configuration is advantageous in that it creates a large installation space radially outside each electrode for the finishing machine's feed mechanisms.

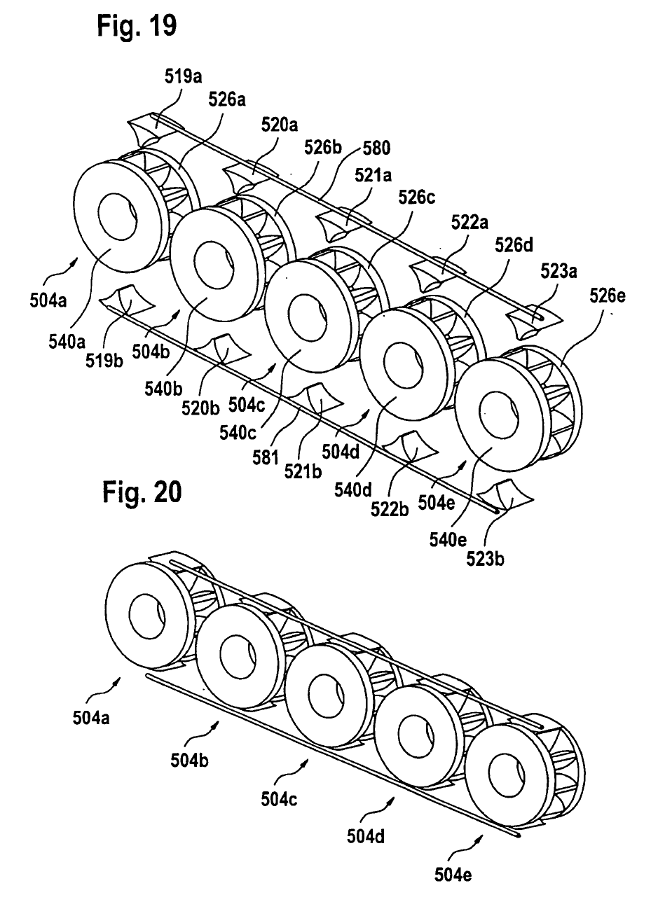

FIG. 19 and FIG. 20 represent toothed gearwheels 504a, 504b, 504c, 504d, 504e according to FIG. 17 and FIG. 18 which are provided with reinforcing covers 526a, 540a, 526b, 540b, 526c, 540c, 526d, 540d, 526e, 540e on both sides in a multiple machining device.

The electrodes 519a, 520a, 521a, 522a, 523a and 519b, 520b, 521b, 522b, 523b allocated to each machining side are conductive connected by means of a first carrier bridge 580 and 581 respectively. Another machining side is situated diametrically opposed to the first side relative to the longitudinal axes of the toothed gearwheels 504a, 504b, 504c, 504d, 504e. The electrodes 519b, 520b, 521b, 522b, 523b and 519a, 520a, 521a, 522a, 523a, respectively, allocated to the other machining side are conductively connected by means of a second carrier bridge 581 and 580 respectively. The machining of the toothed gearwheels 504a, 504b, 504c, 504d, 504e is performed analogously to the example according to FIG. 15 and FIG. 16, except the two carrier bridges 580, 581 simultaneously [move] the electrodes 519b, 520b, 521b, 522b, 523b, 519a, 520a, 521a, 522a, 523a into the intervening spaces up to a flushing gap, which halves the machining time compared with one-sided machining, according to FIG. 17 and FIG. 18.

The simultaneous multi-sided machining of multiple toothed gearwheels as represented in this exemplifying embodiment can also be used for machining the pinion shafts according to FIG. 15 and FIG. 16.

In all exemplifying embodiments, three or more sides can be machined, so more than only two intervening spaces can be electrochemically processed simultaneously on each toothed gearwheel. Assuming an appropriately segmented guidance, all sides can even be machined simultaneously, and the running gear of an entire toothed gearwheel can be finished in a single electrochemical machining step.

A ring gear with double sided toothing can be electrochemically machined with an electrode on each side configured according to FIG. 1 and FIG. 2 respectively. Thus the two electrodes would sandwich the ring gear double sided toothing and enclose it up to a flushing gap. This kind of ring gear can transmit especially high torques in a differential or axle transmission. The non-prepublished German patent application DE 103 39 423.0 described this kind of ring gear with toothing on both sides for a differential. This ring gear can be designed with a crown gearing or a bevel gearing. When it has been electrochemically machined on both sides, the ring gear can be used in other functions as well.

In an alternative development of the exemplifying embodiments represented in FIG. 12 to FIG. 20, the running gear of the pinion shaft or the gearwheel can also be partly turned further even when the electrode has not yet been fully withdrawn yet. This can accelerate this multi-step electrochemical machining process by shortening the time frames of the total machining in which there is no electrochemical erosion.

All toothed gearwheels from all exemplifying embodiments can be used as running gear for all purposes. In particular, the running gear can used as face gearing, bevel gearing, spur gearing, helical gearing, spiral gearing, such as hypoid gearing, and as crown gearing. It can also be used for gear rods and, for instance in planetary drives. In all these types of gears, the production method of the invention makes possible a reinforcing cover or a reinforcing rib for increasing the rigidity.

The embodiments described are merely for exemplifying purposes. It is possible to combine the described features for different embodiments. Further features, particularly ones not described, of the device parts comprised by the invention derive from the represented geometries of said parts. Since modifications of the disclosed embodiments incorporating the spirit and substance of the invention may occur to persons skilled in the art, the invention should be construed to include everything within the scope of the appended claims and equivalents thereof.

What is claimed is:

1-20. (canceled)

21. A method for producing a running gear toothing, comprising the steps of:
forming a running gear toothing by forging or casting a first toothing shape; and
electrochemically machining the first toothing shape into a final toothing shape,
wherein in the electrochemically machining step, an electrochemical machining electrode has a negative shape of an individual space between teeth of the toothing and is moved toward the running gear toothing up to a flushing gap therebetween.

22. The production method according to claim 21, wherein the running gear toothing is formed with oversized dimensions.

23. The production method according to claim 22, wherein in the electrochemically forming step, the electrode is moved into at least one intervening space between the teeth of the running gear up to the flushing gap, while the running gear is located in an electrolyte bath.

24. The production method according to claim 23, wherein a voltage is applied between the running gear and the electrode.

25. The production method according to claim 24, wherein the electrode has a negative shape of an overall running gear toothing and machines the running gear toothing by chucking.

26. The production method according to claim 25, wherein the running gear toothing belongs to a toothed gearwheel, and the electrode is fed to the running gear with a relative movement axially with respect to a rotational axis of the gearwheel of the running gear during the electrochemically machining step.

27. The production method according to claim 26, wherein the running gear toothing is a helical or spiral toothing, and the electrode rotates in a relative fashion according to the helical or spiral toothing during its relative axial movement during the electrochemically machining step.

28. The production method according to claim 24, wherein the electrode has a negative shape of a single intervening space between teeth.

29. The production method according to claim 28, wherein a plurality of electrodes which are provided with the negative shape of a single space between teeth are simultaneously fed to the running gear during the electrochemically machining step.

30. The production method according to claim 28, wherein the electrode is fed to the running gear radially.

31. The production method according to claim 29, wherein the electrodes are conductively interconnected.

32. The production method according to claim 21, wherein a reinforcing rib is formed at the teeth of the running gear as one piece in the intervening spaces between the teeth.

33. The production method according to claim 21, wherein a reinforcing rib extends between the teeth of the running gear at least on one of the front ends of its teeth.

34. A running gear toothing, comprising:
a forged or cast running gear toothing having an electrochemically machined final toothing shape,
wherein a reinforcing rib extends between the teeth of the running gear at least on one of front ends of teeth of the toothing.

35. The running gear toothing according to claim 34, wherein the running gear toothing belongs to a gearwheel with a front side configured to receive an electrode having a recess with an internal toothing in the negative shape of an overall running gear toothing.

36. The running gear according to claim 35, wherein the running gear toothing is a spiral toothing.

37. The running gear according to claim 34, wherein the running gear toothing belongs to a ring gear on configured to receive an electrode having on a front side a toothing in the negative shape of an overall running gear toothing.

38. The running gear according to claim 36, wherein the ring gear comprises a surrounding reinforcing rib.

39. The running gear according to claim 37, wherein the ring gear is formed on a differential casing as one piece.

40. The running gear according to claim 34, wherein the running gear toothing is part of a differential spur gear of a crown gear differential which is provided with reinforcing covers on both sides.

41. The running gear according to claim 34, wherein a surface of a rolling region of the running gear is generated through electrochemical erosion.
